(19) United States
(12) Patent Application Publication
(10) Pub. No.: US 2011/0190162 A1
(43) Pub. Date: Aug. 4, 2011

(54) METHOD OF NUCLEIC ACID DELIVERY INTO THREE-DIMENSIONAL CELL CULTURE ARRAYS

(76) Inventors: Moo-Yeal Lee, Burlingame, CA (US); Seok Joon Kwon, Niskayuna, NY (US); Jonathan S. Dordick, Schenectady, NY (US); Douglas S. Clark, Orinda, NY (US); Jessica R. McKinley, Oakland, CA (US)

(21) Appl. No.: 12/945,214

(22) Filed: Nov. 12, 2010

Related U.S. Application Data
(60) Provisional application No. 61/311,572, filed on Mar. 8, 2010.
(60) Provisional application No. 61/281,062, filed on Nov. 12, 2009.

(51) Int. Cl. C40B 30/06; C40B 40/02; C40B 50/06

(52) U.S. Cl. 506/10; 506/14; 506/26

(57) ABSTRACT

The invention is directed to a three-dimensional cell culture array comprising spatially-separated matrices attached to a solid support, wherein a plurality of said matrices encapsulate cells transfected with nucleic acids, method for the preparation of the array and methods reducing the expression of a target gene.

### RELATED APPLICATION

This application claims the benefit of U.S. Provisional Application Ser. No. 61/311,572 filed Mar. 8, 2010 and U.S. Provisional Application Ser. No. 61/281,062 filed Nov. 12, 2009. The entire teachings of the above applications are incorporated herein by reference.

### GOVERNMENT SUPPORT

The invention was supported, in whole or in part, by a grant IIP-0740592 from the National Science Foundation. The Government has certain rights in the invention.

### BACKGROUND OF THE INVENTION

The wealth of genome-sequence information and transcriptomic data generated by sequencing projects and microarray studies, without commensurate functional data, has created a demand for high-throughput methods for annotating gene function. Recently, Ziauddin and Sabatini demonstrated that cDNA expression vectors could be spotted onto glass slides in gelatin, exposed to a lipid transfection reagent, and then overlaid with a culture of adherent cells, creating ‘transfected cell microarrays’¹. This technique was extended by Silva and coworkers to include small interfering RNAs (siRNAs) and short hairpin RNAs (shRNAs), allowing for loss of function studies², and more recently, by Bailey et al. to include lentiviral infection of shRNAs, permitting transfection of a wider range of cell types³. While these techniques have provided substantial advances in profiling gene function, they are limited by the need to culture adherent cells in a two-dimensional (2D), monolayer culture environment, i.e. attached to the glass slide. Hence, they cannot be applied to hematopoietic cells or to suspension cell cultures of greatest use to the biotechnology industry (e.g., Chinese hamster ovary (CHO), NS0 myeloma cells). More significantly, the 2D monolayer culture poorly reflects the in vivo cellular milieu⁴⁻⁶, limiting the ability of these transfected cell microarrays to predict the cellular responses in vivo.

It would therefore be advantageous to provide three-dimensional arrays comprising cells in suspension culture transfected with a foreign nucleic acid.

### SUMMARY OF THE INVENTION

The present invention is based on the discovery that cells in suspension culture in three-dimensional arrays can be transfected using viral delivery methods. For example, as shown below, three-dimensional cellular arrays can be used for high-throughput retroviral transfection of genes and interfering RNA molecules.

In one embodiment, the invention is directed to a three-dimensional cell culture array comprising spatially-separated matrices attached to a solid support, wherein a plurality of said matrices encapsulate cells transfected with nucleic acids. In certain embodiments, the cells encapsulated in the matrices are mammalian cells. In additional aspects, the cells are transfected by contacting said cells with a viral vector comprising the nucleic acid to be delivered. In other embodiments, the matrices are biomatrices. In additional aspects, the matrices are micromatrices. In a further embodiment, at least two of said matrices on the array comprise cells of a different type.

In additional embodiments, the invention encompasses a method of preparing a three-dimensional cell culture array comprising spatially-separated matrices attached to a solid support, wherein a plurality of said matrices encapsulate cells transfected with nucleic acids, said method comprising contacting cells with a viral vector comprising the nucleic acid to be delivered to said cells. In certain embodiments, the cells encapsulated in the matrices are mammalian cells. In some embodiments, the nucleic acid is RNA. In additional aspects, the RNA is capable of mediating RNA interference. In other embodiments, the matrices are biomatrices. In additional aspects, the matrices are micromatrices. In a further embodiment, at least two of said matrices on the array comprise cells of a different type. In yet another embodiment, at least two of said matrices are contacted with different viral vectors. In a further embodiment, the invention is a high-throughput method of preparing the three-dimensional cell culture array.

The invention is also directed to a method of decreasing the expression of a target gene in cells on a three-dimensional cell culture array, said method comprising contacting said cells with a virus comprising a nucleic acid to be delivered to said cells, wherein said nucleic acid is RNA capable of mediating RNA interference or an antisense nucleic acid, said array comprises spatially-separated matrices attached to a solid support, and a plurality of said matrices encapsulate cells. In certain aspects, the target gene is an endogenous gene. In another aspect, the target gene is an exogenous gene. In some embodiments, the method of decreasing the expression of a target gene is a high-throughput method.

In additional embodiments, the cells can be contacted with the viral vector by a method selected from overlaying a matrix that encapsulates the cells with a solution comprising the virus, the virus is applied to cells by overlaying a solution comprising the virus with a solution comprising said cells and preparing cells infected with said virus followed by co-culturing said infected cells with the cells of the three-dimensional array.

The invention also encompasses a method of assaying the effect of a test compound comprising providing a three-dimensional cell culture array comprising spatially-separated matrices attached to a solid support, wherein a plurality of said matrices encapsulate cells transfected with nucleic acids, contacting said three-dimensional cell culture with a test compound and assaying the effect of the test compound on the cells. In certain aspects, the toxicity or cytotoxicity of a test compound is measured. In certain additional aspects, the effect of the test compound on the cells is determined by measuring cell viability. In certain additional aspects, the IC₅₀ of the test compound is calculated. In further aspects, the cells are transfected with nucleic acids encoding a metabolic enzyme. In certain aspects, the cells are transfected with nucleic acids encoding a cytochrome P450 enzyme.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A shows a scanning image of cell spots containing a mixture of Hep3B cells and 293 cells after 2 d incubation.

FIG. 1B shows Green fluorescence of cell spots obtained from Hep3B cells and infected 293 cells (sample) and Hep3B cells and untreated 293 cells (control).

FIG. 2 shows retroviral transfection of CHO-K1 and NIH-3T3 cells grown in 3D cell-culture array using conventional (solution) transfection. a) Transfection of retroviral green fluorescent protein (GFP) construct. b) Silencing of GFP with shRNA against GFP. c) Live/Dead staining of cells transfected with toxic shRNAs. Live cells stain green from metabolism of calcein AM, and dead cells stain red due to permeability of the cells to ethidium homodimer. d) Quantitation of the percent cell death from part c.

FIG. 3 shows high-throughput retroviral transfection of CHO-K1 and NIH-3T3 cells grown in 3D cell-culture arrays. a) Transfection of retroviral constructs containing GFP and dsRed-Monomer (Clonetech) demonstrating our ability to deliver multiple constructs to a single slide. b) Live/Dead staining of cells transfected with toxic shRNAs in a high-throughput manner (multiple shRNAs per slide). c) Quantitation of the percent cell death from part b, showing that comparable cell death could be achieved in high throughput transfection as in conventional solution transfection (FIG. 2D).

FIG. 4 is a schematic of conventional transfection and high throughput transfection methods. In the conventional method, only a single retrovirus can be transfected into each slide. In the high-throughput approach, multiple retroviruses can be spotted and overlaid with multiple different types of cells as demonstrated in FIG. 2.

FIG. 5 shows Live/Dead staining of cells treated with shRNA against GFP. Nearly all cells appear viable, indicating no toxicity from the shRNA construct.

FIG. 6 shows MCF7 (left) and CHO K1 cells (right) were cultured in 24-well plates in alginate matrices. Retroviral particles containing the GFP gene, produced in Phoenix-Ampho cells, were concentrated, mixed with polyrene and applied to the top of the alginate matrix. After 24 hours, fresh medium was added and the cells were incubated for an additional 48 hours. After 48 hours, cells were imaged by fluorescence microscopy.

FIG. 7 shows MCF7 (left) and CHO K1 cells (right) were culture in 60 nl alginate spots on glass slides. Retroviral particles containing the GFP gene, produced in Phoenix-Ampho cells were concentrated, mixed with polybrene and applied to the medium in which the slide was incubated. After 24 hours, fresh medium was added and the cells were incubated for an additional 48 hours. After 48 hours, cells were imaged using a microarray scanner.

FIG. 8 shows MCF7 (left) and CHO K1 (right) cells mixed with a retrovirus containing the gene for GLP prior to mixing with alginate. Cell-alginate mixtures were placed into 24-well plates (top panels) or spotted onto DataChips (bottom panels) allowed to gel for 20 minutes then incubated for 48 hours in complete medium. Fluorescence was detected by fluorescence microscopy (top panels) or microarray scanning (bottom panels).

FIG. 9 shows that GFP expression was silenced by application of a retroviral shRNA against GFP applied on top of the alginate matrix. Top panels show results from experiments in 24-well plates; while bottom panels show results from the DataChip. In Approach A, cells were initially transfected with a retrovirus expressing GFP and allowed to incubate for 72 hours before application of silencing RNA. In Approach B, both the GFP DNA and the silencing RNA were applied simultaneously. Cell lines are indicated beneath each panel.

FIG. 10 shows that GFP expression was silenced by mixing retroviral shRNA with cells prior to alginate gelation. Both the GFP DNA and the silencing RNA were mixed with the cells prior to adding the cells to the alginate. Top panels show results from experiments in 24-well plates; while bottom panels show results from the DataChip. Cell lines are indicate beneath each panel.

FIGS. 11A and 11B shows expression of CYP2C9 and CYP3A4 in HepG2 cells with recombinant adenoviruses carrying CYP2C9 and CYP3A4 genes (Ad-2C9 and Ad-3A4).

FIG. 12 shows dose response curves of acetaminophen with native HepG2 cells and Ad-3A4 infected HepG2 cells.

### DETAILED DESCRIPTION OF THE INVENTION

A description of preferred embodiments of the invention follows.

The words “a” or “an” are meant to encompass one or more, unless otherwise specified.

As used herein, a “plurality” is defined as more than one.

A three-dimensional cell culture array is an array comprising multiple matrices on a support, wherein a plurality of said matrices comprise cells, for example, in suspension culture. In certain aspects, all of the matrices on the support comprise cells in suspension culture. Three-dimensional cell culture arrays and methods of use thereof have been described, for example, in U.S. Patent Application Publication No. 20100056390, U.S. Patent Application Publication No. 20090221441, Lee et al., Three-dimensional cellular microarray for high-throughput toxicology assays, PNAS 105(1): 59-63 (2008), and Fernandes et al., On-Chip, Cell-Based Microarray Immunofluorescence Assay for High-Throughput Analysis of Target Proteins, Anal. Chem. 80: 6633-6639 (2008); Jongpaiboonkit et al., An adaptable hydrogel array format for 3-dimensional cell culture and analysis, Biomaterials 29(23): 3346-3356; the contents of each of said references are expressly incorporated by reference herein. In certain aspects, the three-dimensional cell culture array comprises a chemically modified support on which a plurality of independent spots are spotted or attached, wherein each spot comprises a matrix containing cells. In additional aspects, the three-dimensional cell culture array comprises a chemically modified support on which a plurality of independent spots are attached, wherein each spot comprises a matrix containing cells and a matrix bottom layer.

The matrix bottom layer can comprise a sol-gel, an inorganic material, an organic polymer, a hybrid inorganic-organic material or a biological material. In some aspects, the matrix bottom layer comprises poly-L-lysine (PLL)-barium chloride mixture. The matrix comprising cells can be any three-dimensional matrix that supports cells growth. In certain embodiments, the matrices on the array are biomatrices. In additional aspects, the matrices on the array are micromatrices. Exemplary matrices that support cell growth are hydrogels. A hydrogel is a matrix material, such as collagen, hyaluronic acid, polyvinyl alcohol, polysachharides, etc, that be used to support and restrain cells in a specific area. Specific examples of hydrogels include, but are not limited to, collagen and alginate.

A specific example of a three-dimensional cell culture array comprising a matrix bottom layer and a layer comprising cells is the Data Analysis Toxicology Assay Chip (DataChip) which encapsulates human cells arrayed on functionalized (chemically-modified) supports. The DataChip has been described in detail, for example, in U.S. Patent Application Publication No. 20090221441. In certain aspects of the invention, the three-dimensional array comprises matrices that encapsulate human cells on a chemically modified support. In an additional embodiment, the cell-culture array is the DataChip.

The support of the cell culture array is the substrate upon which matrices comprising cells are attached (either directly or indirectly) or spotted. The support can be made from any appropriate material that permits attachment or spotting of the matrices described herein. Exemplary materials are glass, plastic and silicon. As described above, in some aspects, the support can be chemically modified. Such chemical modification is meant to encompass contacting, treating or coating the support or substrate with a compound or agent whereby the surface is altered in a manner that aids or facilitates the attachment (either ionic or covalent) of a matrix to the surface of the support. Exemplary agents that can be used to chemically modify the support include, for example, of poly(styrene-co-maleic anhydride), 3-(aminopropyl)trimethoxysilane (APTMS), methyltrimethyoxysilane (MTMOS), propyltrimethoxysilane (PTMOS), octyltrimethoxysilane and a combination of any of thereof.

Detailed methods for chemically modifying a support suitable for use in a three-dimensional cell culture array have been described for example in U.S. Patent Application Publication No. 20090221441.

Matrices are spatially separated from one another on a solid support when they are located at some distance from one another. In some aspects, the distance is sufficient to prevent cross-talk or cross-reaction between the matrices. In other aspects, the matrices are spatially separated but are not separated from one another by wells, walls or other physical means of separation other than spatial separation (for example, a plurality of micromatrices spotted on a glass or plastic slide).

The words “transfection” and “delivery” or “transfected” or “delivered” are used interchangeably herein and are meant to refer to the introduction of foreign nucleic acids to cells.

Cells or a cell culture are “encapsulated” in a matrix when the cells are contained or suspended within the volume of matrix. In some examples, cells can be encapsulated in matrix material after gelation. Encapsulation is distinct from surface immobilization or surface attachment because the cells are contained within the three-dimensional volume of the matrix. As described above, the matrix material can, for example, be a hydrogel. Using alginate as an example, cells can be placed in alginate solution and can be subsequently “encapsulated” in an alginate matrix when the alginate is cross-linked to form a gel.

Various cells can be encapsulated in the matrices of the three-dimensional arrays. For examples, cells can be derived from tissues or organs, including, but not limited to bone marrow, skin, cartilage, tendon, bone, muscle (including cardiac muscle), blood vessels, corneal, neural, brain, gastrointestinal, renal, liver, pancreatic (including islet cells), lung, pituitary, thyroid, adrenal, lymphatic, salivary, ovarian, testicular, cervical, bladder, endometrial, prostate, vulval, esophageal, and the like. Exemplary cells also include immune cells such as T lymphocytes, B lymphocytes, polymorphonuclear leukocytes, macrophages, and dendritic cells. The cells can additionally be mammalian cells, such human and murine cells. Specific examples of cell types that can be used according to the present invention include Chinese hamster ovary (CHO) cells, NIH3T3 cells, Hep3b cell, human embryonic kidney (HEK) cells, A293T cells and cancerous or tumor cells.

In certain embodiments, the array comprises at least two micromatrices that encapsulate different cell types. Two micromatrices encapsulate cells of different type when, for example, the cells are different cell lines.

As will be understood by the skilled artisan, the term nucleic acid encompasses deoxyribonucleic acid (“DNA”) and ribonucleic acid (“RNA”) and further encompasses sequences that include any of the known base analogs or derivative of DNA and RNA. DNA includes, for example, antisense DNA and chromosomal DNA. RNA includes, for example, tRNA (transfer RNA), snRNA (small nuclear RNA), rRNA (ribosomal RNA), mRNA (messenger RNA), antisense RNA, interfering or interference RNA (double-stranded and single-stranded RNA) (referred to herein as RNAi), ribozymes, chimeric sequences, as well as derivatives or analogs of any of thereof.

An antisense nucleic acid is a nucleic acid that interferes with the function of DNA and/or RNA which in turn can suppress expression.

RNA interference or interference RNA (“RNAi”) can also be used to reduce gene expression and/or in gene silencing. RNAi refers to a selective intracellular degradation of RNA. RNAi encompasses the process whereby double-stranded RNA (dsRNA) induces the sequence-specific degradation of specific mRNAs. RNAi has been described extensively in the literature, for example in, Bass (2001), Nature 411: 428-429, Elbashir et al. (2001), Nature, 411: 494-498, WO01/44895, WO01/36646, WO99/32619, WO00/01846, WO01/29058, WO99/07049 and WO00/44914, the contents of each of which are expressly incorporated by reference herein. In some aspects, the nucleic acid is a nucleic acid capable of mediating RNAi. In certain additional aspects, the nucleic acid capable of mediating RNAi is double-stranded RNA (dsRNA) which encompasses a nucleic acid molecule comprising one or more ribonucleotides and that is capable of mediating RNAi or inhibiting or suppressing gene expression. A dsRNA can be a substrate for Dicer (as described, for example, in WO2009/046220). As used herein, dsRNA molecules, in addition to at least one ribonucleotide, can further include substitutions, chemically-modified nucleotides, and non-nucleotides. Exemplary dsRNA molecules include, for example, meroduplex RNA (mdRNA), nicked dsRNA (ndsRNA), gapped dsRNA (gdsRNA), short interfering nucleic acid (siNA), siRNA, micro-RNA (miRNA), short hairpin RNA (shRNA), short interfering oligonucleotide, short interfering substituted oligonucleotide, short interfering modified oligonucleotide, and chemically-modified dsRNA. Small interfering RNA″ (“siRNA”) (also referred to as “short interfering RNAs”) encompasses a double-stranded nucleic acid capable of RNAi. siRNA encompass molecules containing chemically modified nucleotides and non-nucleotides. Short hairpin RNAs (shRNAs) are capable of mediating RNA interference. The term shRNA encompasses a single RNA strand that contains two complementary regions that hybridize to one another to form a double-stranded “stem,” with the two complementary regions being connected by a single-stranded loop.

In some aspects, the nucleic acid is delivered to the cell for the intended purpose of inhibiting or suppressing gene expression and/or for RNAi. In additional embodiments, the nucleic acid is an antisense nucleic acid or an RNA capable of mediating RNAi. As will be understood by the skilled artisan, an RNA capable of mediating RNAi that inhibits the expression of a target gene has a nucleotide sequence of the duplex portion (or double-stranded portion) that is complementary to a nucleotide sequence in the target gene. While sequence-specific cleavage of target mRNA is currently the most widely used means of achieving gene silencing by delivery of RNAi have been described. For example, post-transcriptional gene silencing mediated by small RNA molecules can occur by mechanisms involving translational repression. Certain endogenously expressed RNA molecules form hairpin structures containing an imperfect duplex portion in which the duplex is interrupted by one or more mismatches and/or bulges. These hairpin structures are processed intracellularly to yield single-stranded RNA species referred to as known as microRNAs (miRNAs), which mediate translational repression of a target transcript to which they hybridize with less than perfect complementarity. siRNA-like molecules designed to mimic the structure of miRNA precursors have been shown to result in translational repression of target genes when administered to mammalian cells and are encompassed by the term RNAi and/or dsRNA.

As described above, the invention is also directed to a method of preparing a three-dimensional cell culture array comprising spatially-separated biomatrices attached to a solid support, wherein a plurality of said biomatrices encapsulate cells transfected with nucleic acids, said method comprising contacting cells with a viral vector comprising the nucleic acid to be delivered to said cells. The cells can be contacted with the virus encapsulating the nucleic acid by any suitable method including, but not limited to, overlaying a matrix that encapsulates the cells with a solution comprising the virus, overlaying a solution comprising the virus with a solution comprising said cells, mixing a solution comprising said virus with said cells prior to introducing said cells and viral solution in the matrices and/or co-culturing cells infected with a viral vector with the cells of three-dimensional microarray (before or after encapsulation of the cells in the matrices). In certain aspects, the contacting step is accomplished by contacting cells already encapsulated in a matrix with a solution comprising the viral vectors, for example, applying the virus-containing solution to the surface of the matrices encapsulating cells or by placing the support comprising the matrices in a virus-containing solution. The viral vectors can therefore be used to deliver nucleic acids through the matrices, for example, alginate matrix. In additional aspects, transfection of encapsulated cells is accomplished when a solution containing the virus is mixed with cells prior to encapsulation in the matrices. In yet other aspects of the invention, the contacting step is accomplished by infecting a first set of cells with the viral vectors followed by co-culturing the first set of cells with a second set of cells, wherein said second set of cells are already or will be encapsulated in matrices on the cell-culture array.

The use of viral vectors to deliver foreign nucleic acids to cells has been described extensively in the literature, including, for example, Walther et al. (2000), Drugs 60(2): 249-71, Young et al. (2006), J. Pathol. 208(2): 299-318. Viral vectors comprising a foreign nucleic acid to be delivered can be prepared from, for example, adenovirus, retrovirus, adeno-associated virus, herpesvirus, lentivirus, vaccinia virus and baculovirus. In some aspects, the virus that encapsulates the nucleic acid to be delivered is an adenovirus or retrovirus. There are more than 40 different adenovirus varieties. Retroviruses belong to the family Retroviridae and use reverse transcriptase to copy its genome into DNA and integrate into the host cell's chromosome. Viruses comprising the nucleic acid to be delivered can be produced using known methods. For example, the nucleic acid of interest can be added to an existing virus and/or a viral sequence can be replaced with the nucleic acid sequence to make a replication-defective vector. Such replication-defective viral vectors contain, in addition to the foreign gene of interest, the cis-acting sequences necessary for viral replication but not sequences that encode essential viral proteins. Such a vector is unable to complete the viral replicative cycle, and a helper cell line, which contains and constitutively expresses viral genes within its genome, is employed to propagate it. Following introduction of a replication-defective viral vector into a helper cell line, proteins required for viral particle formation are provided to the vector intrans, and vector viral particles capable of infecting target cells and expressing therein the gene, which interferes with viral replication or causes a virally infected cell to die, are produced. For example, as described in Example 1, a recombinant adenovirus carrying the EGFP gene was constructed using the Cre-lox recombination system. Methods of preparing and/or amplifying a virus encapsulating the nucleic acid to be delivered can be accomplished by infecting cells with the modified virus, for example, a monolayer of cells can be infected by adding a virus-containing solution to the growth medium followed by incubation. It is to be understood that the cells used for preparation of the viral vector are distinct from the cells encapsulated in a matrix on the three-dimension microarray described herein. Exemplary cells that can be infected with the modified virus (or the virus encapsulating the nucleic acid to be delivered) include 293T cells and COS-7 cells. A non-limiting example of a method of co-culturing infected cells with cells in suspension is described in Example 1. In some aspects of the invention, at least two different viral vectors are used to deliver nucleic acids to at least two micromatrices. Viral vectors are different, for example, when they are based on different virus (e.g., adenovirus and a retrovirus) and/or when they encapsulate different foreign nucleic acids.

The invention is additionally directed to a method of decreasing expression of a target gene comprising contacting cells on the three-dimensional array with a virus encapsulating an antisense nucleic acid or RNA capable of mediating RNAi. Gene expression is decreased or suppressed when expression of a gene product is reduced. Non-limiting examples of a gene product include RNA transcribed from a gene (mRNA) and a polypeptide translated from mRNA. Gene expression can therefore be decreased by a method that affects transcription and/or a method that affects post-transcriptional mechanisms. The target gene in the method of decreasing gene expression is a gene that is suppressed by the nucleic acid encapsulated by the virus. The level of expression can be determined using methods known in the art for measuring RNA and/or polypeptides.

The invention also encompasses a method of assaying the effect of a test compound on cells comprising providing the three-dimensional cell culture array as described herein, contacting said three-dimensional cell culture with a test compound and assaying the effect of the test compound on the cells. In certain aspects, the toxicity or cytotoxicity of the test compound is measured. In certain additional aspects, the effect of the test compound on the cells is determined by measuring cell viability. In certain additional aspects, the IC₅₀ of the test compound is calculated. In additional aspects the cells are mammalian cells, for example human cells. In further aspects, the cells are transfected with a nucleic acid encoding a metabolic enzyme, for example, a human metabolic enzyme. In certain additional aspects, the cells are transfected with a nucleic acid encoding a cytochrome P450 enzyme.

Methods of using three-dimensional arrays to measuring the effect of drugs or test compounds have been described, for example, U.S. Pat. No. 7,267,958, the contents of which are expressly incorporated by reference herein. The invention can be used, for example, to test side effects of a drug in humans. A reaction between a drug and an encapsulated human metabolic enzyme on the apparatus can produce a product, called a metabolite. If cells at a location are killed or otherwise undergo a measurable physiological or morphological change by the metabolite produced at that location, it indicates that the drug will likely have an effect, which may be toxicity. The invention can also be used, for example, to optimize a potential drug candidate or pharmacophore to improve its efficacy and/or reduce its side effects.

As discussed above, the cells of the three-dimensional cell culture array can be transfected with a nucleic acid that encodes a cytochrome P450 enzyme. The human liver includes 16 major isoforms responsible for the vast majority of xenobiotic metabolism (Table 1). A summary of the relative amounts of P450 isoforms responsible for drug metabolism in the uninduced human liver is given in Table 2. Further, this capability can be expanded to accommodate differences in P450 isoform levels, and mutations among isoforms, allowing investigation of the influence of P450 variability on drug metabolism in an individual, a related group of individuals, a population subgroup, a pathological profile, and the like.

TABLE 1
Summary of Commerically Available P450 Isoforms, their Substrates
(Xenobiotics), and Known Inhibitors

| P450 | Representative Substrates | |
|---|---|---|
| Isoform | (fluorogenic ones given in bold) | Representative Inhibitors |
| 1A1 | PAHS (e.g., benzo[a]pyrene, pyrene), 7- | Ellipticine |
| | ethoxyresofuffin | |
| 1A2 | Aromatic amines, PAHs, caffeine, | Furafylline, verapamil, |
| | coumadin, 3-cyano-7 etboxycoumarin | diltiazern |
| 2A6 | Coumarin, nicotine, steriods, valproic acid | Trancypromine, |
| | | diethyldithiocarbarnate |
| 2C8 | Paclitaxel, ibuprofen, dibenzylflourescein | Quercitin, omeprazole |
| 2C9 | Dieolfenac, ibuprofen, omeprazolc, | Sulfaphenaole, cimetidine, |
| | coumadin, tamoxifen, dibenzylfluorescein | fluotetine, valproic acid |
| 2C18 | Imipramine, naproxen, omeprazole | Cimetidine, fluoxetine, |
| | | omeprazole |
| 2D6 | Capropril, dextramethorphan, tramadol, codein, | Qunidine, codeine, |
| | 3-[2-(n₃N-diethyl-N-methylamine)ethyl]-7- | haloperidol, valproic acid |
| | methoxy-4-methylcoumarin | |
| 2E1 | Acetaminophen, chlorzoxezone, 7- | Diethylidithiocarbamate, |
| | methoxy-4-trifuloromethylcoumarin | ritonavir |
| 3A4 | Atorvastain, cortisol, cyclophosphamide, | Ketoconzaole, |
| | digitoxin, indinavir, loratidine, lovastatin, | erythromycin, fluconazole |
| | paclitaxel, tamosifen, testoterone, | |
| | terfenadine, dibenzylfluorescein | |
| 3A5 | Cortisol, lovastatin, terfenadine | Ketoconazole, Miconazole |
| 3A7 | Cortisol, lovastatin, terfenadine | Ketoconazole, miconazole |
| 4A11 | Lauric acid | 1-Aminobenzotriazole |
| 4F2 | Arachadonic acid, Leukotriene B₄ | 17-Octadecynoic acid |
| 4F3A & B | Leukotriene B₄ | Quercitin, ketoconzaole |

TABLE 2
Representative Distribution of P450 Isoforms in the Human Liver³⁴

| P450 Isoform | Average % of Total Liver P450 |
|---|---|
| 1A2 | 13 |
| 2A6 | 4 |
| 2B6 | 1 |
| 2C8, 2C9, 2C18, 2C19 | 18 |
| 2D6 | 2.5 |
| 2E1 | 7 |
| 3A4, 3A5 | 28 |

Nucleic acid encoding a wide variety of other enzymes from other organs, and other organisms can also be used in the inventive method of assaying the effect of a test compound. Nucleic acid encoding enzymes that recognize substrates instead of transforming them, such as receptors, can be, for example, used.

Non-limiting examples of cells that can be used in method of measuring the effect of a test compound include cancer cell line (MCF7), a human hepatocyte (HepG2 cells), and a kidney cell line (A-498 cells).

The following examples illustrate the invention but are not meant to be limiting in any way.

### EXAMPLES

### Example 1

### Gene Expression Protocol in Microarray Spots

Recombinant adenovirus carrying the EGFP gene (Ad-EGFP) was constructed by employing the Cre-lox recombination system (J. Virol. 1997, p 1842-1849). For amplification of Ad-EGFP, a monolayer of 293 cells grown in 10% FBS-supplemented DMEM was infected with Ad-EGFP by adding adenovirus solution (1 mL) in 20 mL of the growth medium. After incubation for 3 h in a CO₂ incubator, the medium was removed and changed to fresh DMEM. Following a 1 h incubation, 293 cells infected with Ad-GFP were trypsinized and mixed with fresh suspension of Hep3B cells. The mixing ratio of Hep3B cells (6×10⁷ cells/mL) to infected 293 cells (3×10⁶ cells/mL) was 20 to 1. As a control, a mixture of Hep3B cells and fresh untreated 293 cells was prepared. After printing 30 mL of both the mixture of Hep3B and infected 293 cells for expression of EGFP and the mixture of Hep3B and untreated 293 cells as a control onto 30 mL of PLL-BaCl₂ spots, the cell chip was incubated in 10% FBS-supplemented DMEM for 2 d.

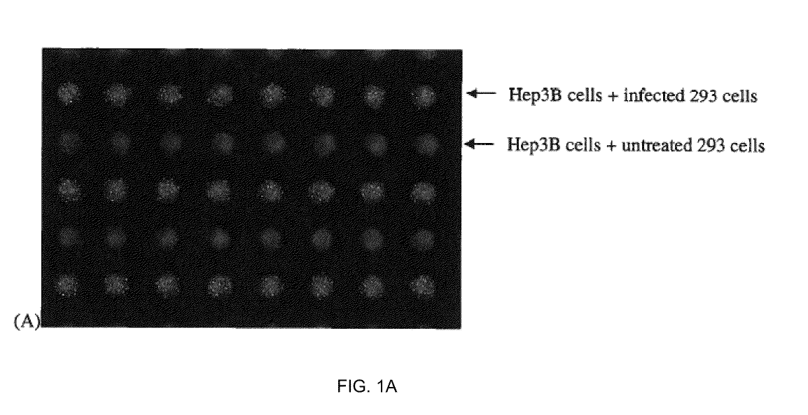

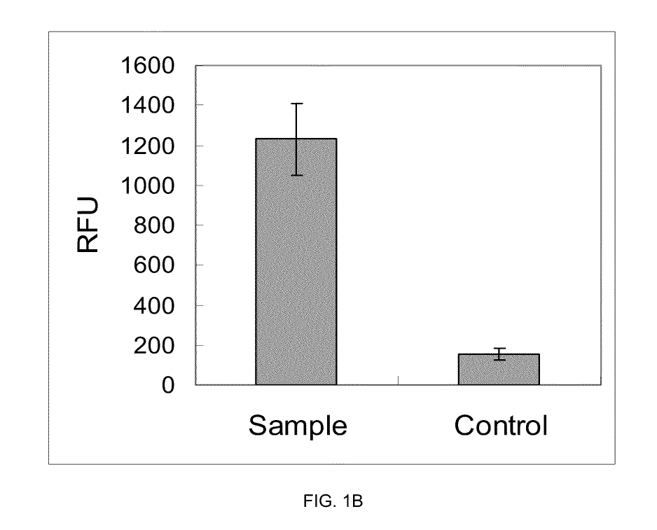

As shown in FIG. 1, GFP was successfully over-expressed in Hep3B cells. Spot-to-spot variation of transfection efficiency was less than 20%. Furthermore, there was no cross-contamination found between cell spots due to diffusion of virus. Thus, printing a mixture of Hep3B cells and 293 cells carrying target genes would be more efficient for transfecting target genes than direct printing of virus.

### Example 2

### High-Throughput Delivery of Interfering RNA to a Three-Dimensional Cell-Culture Chip

Described here is a method for high-throughput retroviral transfection of genes and interfering RNA into three-dimensional (3D) cell-culture microarrays. 3D cultures more closely mimic the in vivo cellular milieu, thus providing cellular responses to genetic manipulation more similar to the in vivo situation than two-dimensional cultures. This technique was applied to transfect several “toxic” short-hairpin RNAs (shRNAs) into 3D cell cultures and demonstrated that the toxicity was similar to that obtained by conventional (non high-throughput) retroviral transfection of cells grown in similar 3D culture microarrays.

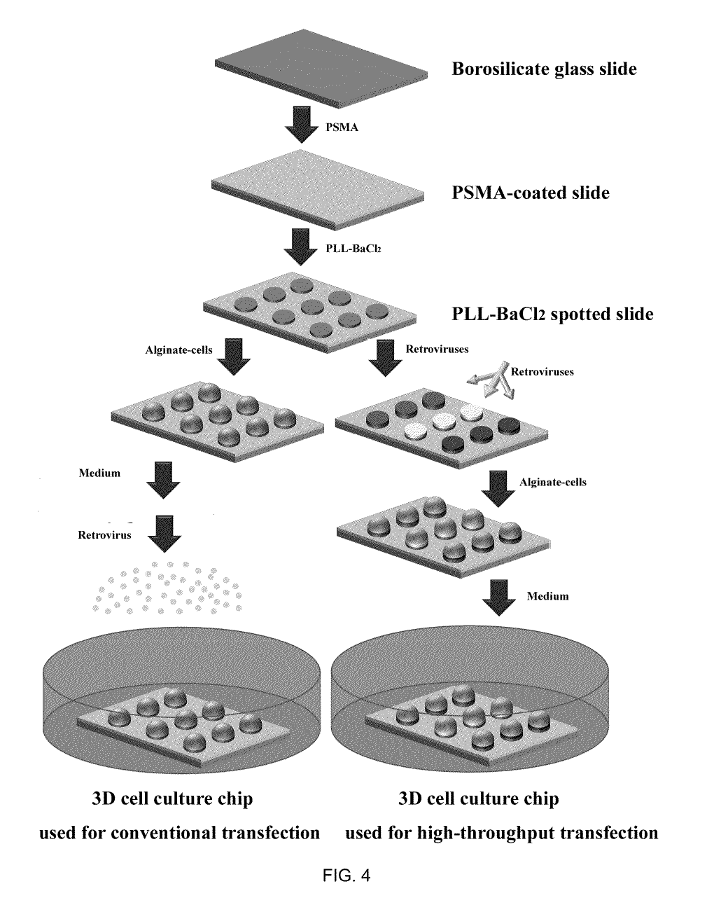

We have recently developed a 3D cell-culture microarray with cells immobilized in 20-60 nL spots of cross-linked alginate that better reflects this in vivo microenvironment. We have applied these arrays to toxicology screening of small organic molecules⁷ and high-throughput analysis of target proteins using in-cell, on-chip immunofluorescence assays⁸. In addition to permitting high-throughput analysis and a 3D culture environment, these arrays maintain spatial separation between “cell spots”, reducing the risk of crosstalk between adjacent spots. In this paper, we demonstrate the utility of these cellular arrays for high-throughput retroviral transfection of genes and interfering RNA molecules and show that the transfection and gene silencing efficiencies are comparable to that obtained in the arrays transfected in a classical, solution-based approach (FIG. 4).

As described previously⁷ (and in the methods), glass microscope slides were used for the 3D cell-culture microarrays. To maintain separation between the individual spots, the slides were first coated with poly(styrene-co-maleic anhydride) (PSMA), providing a hydrophobic surface that would cause the hydrophilic alginate-cell solution to form a semispherical spot. A 40-nl mixture of poly-L-lysine (PLL) and BaCl₂ was spotted onto the PSMA-coated glass slides using a microarrayer. BaCl₂ was used instead of the more common CaCl₂ because it is stable in the presence of phosphate buffer. The positively charged PLL promotes attachment of the negatively charged polysaccharide constituent of alginate upon gelation. In addition, the maleic anhydride groups of PSMA can covalently bind the amine groups in PLL to form stable amide bonds, further promoting attachment. Each slide was spotted with 20×54 (1,080) alginate spots. After allowing the PLL-BaCl₂ spots to dry, 40 mL of cell-alginate solution (8×10⁶ cells/mL in 1% (w/w) alginate) was spotted onto the surface of the PLL-BaCl₂ spots, causing alginate gelation. The spots were uniform with a diameter of 535 μm and contained ˜320 cells; the center-to-center distance between spots was 1.2 mm. Two cell types were used in these studies, NIH 3T3 cells and Chinese hamster ovary (CHO-K1) cells.

We have previously applied these 3D culture systems successfully for high-throughput toxicology assays, in which small-molecule chemical compounds were delivered through the alginate matrix into the cell cultures. However, nucleic acids are not readily taken up by cultured cells due to repulsive interactions between the negatively charged phosphate backbone of the nucleic acids and the negatively charged cell membrane. Hence, nucleic acid delivery requires a transfection reagent or viral delivery system. Most non-viral vectors for delivery of nucleic acids to cells have positively charged groups that can form stable, positively charged complexes with nucleic acids, which can be easily taken up by cells. However, the alginate hydrogel in our 3D culture system consists of mannuronic and guluronic acid groups in the gel matrix that can prevent the transfection complexes accessing the cells. We examined a variety of commercially available, non-viral transfection reagents to deliver nucleic acids into the 3D cell cultures, but the resulting transfection efficiencies were very low (<1%, Table 1). We also explored magnetic transfection reagents that form nanoscale magnetic complexes which can be driven into the alginate gel matrix by an external magnetic field; however, the transfection efficiencies were still unacceptable (<15%, Supplementary Table 1).

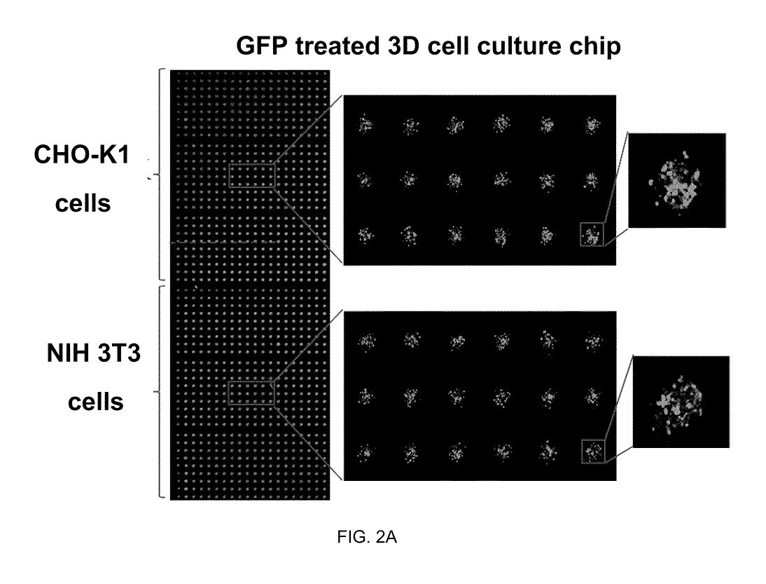

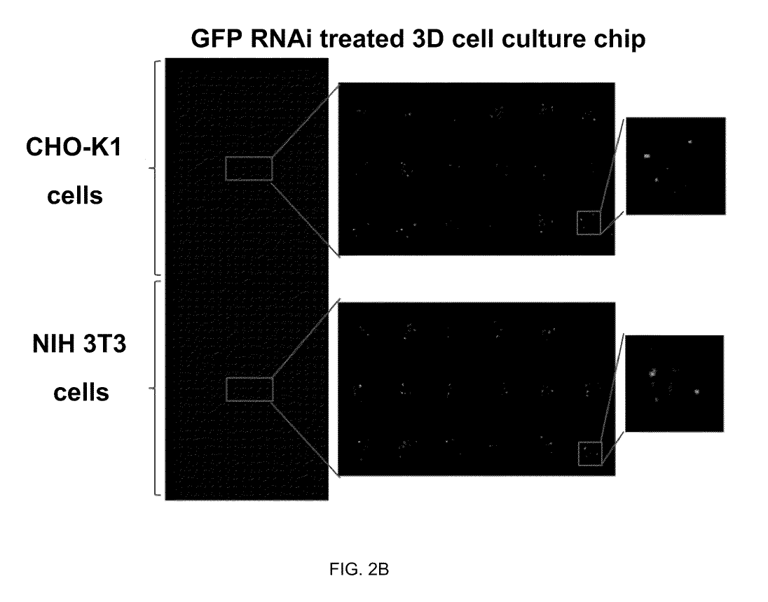

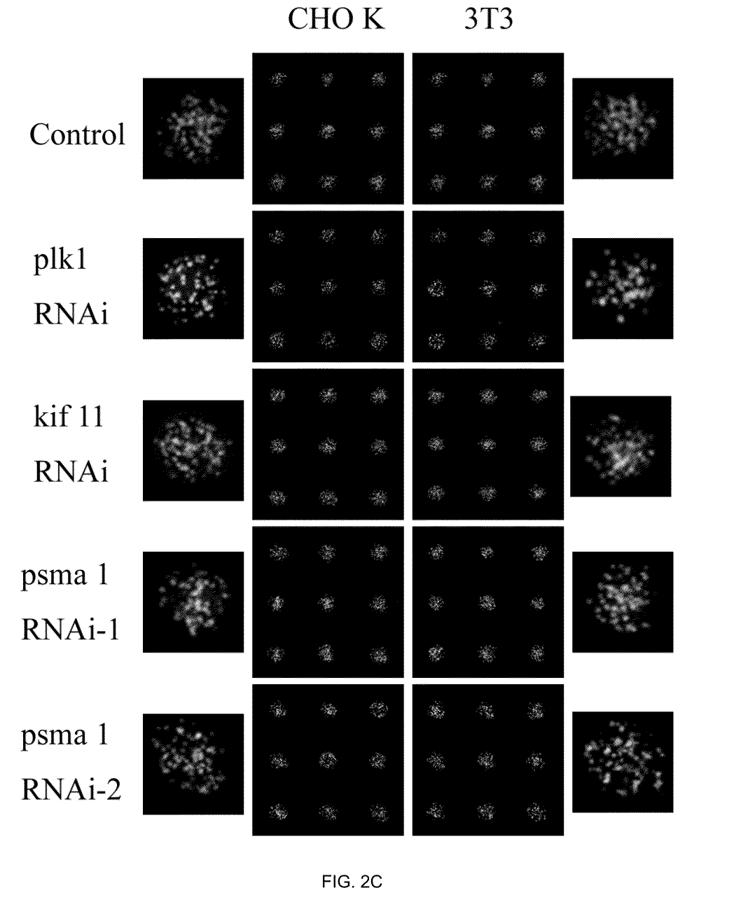

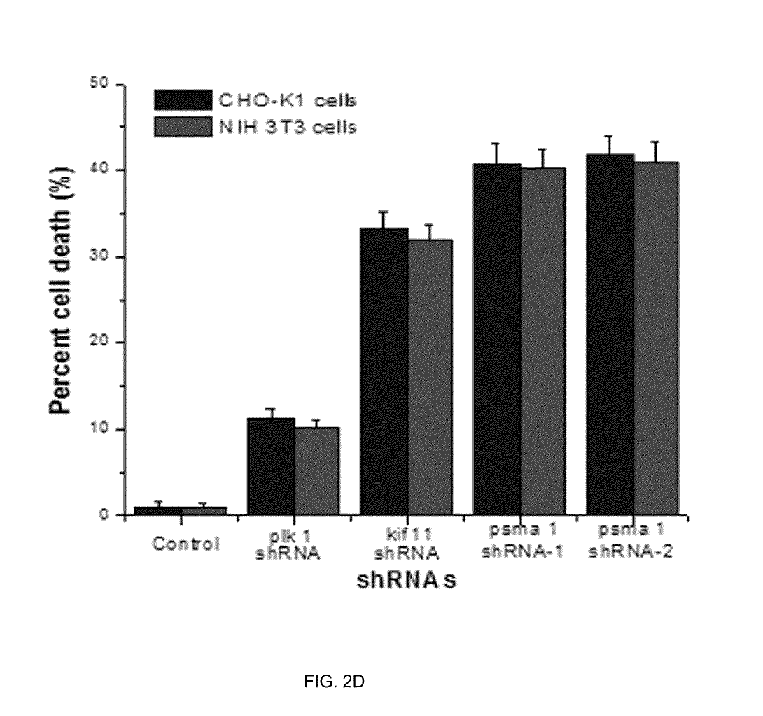

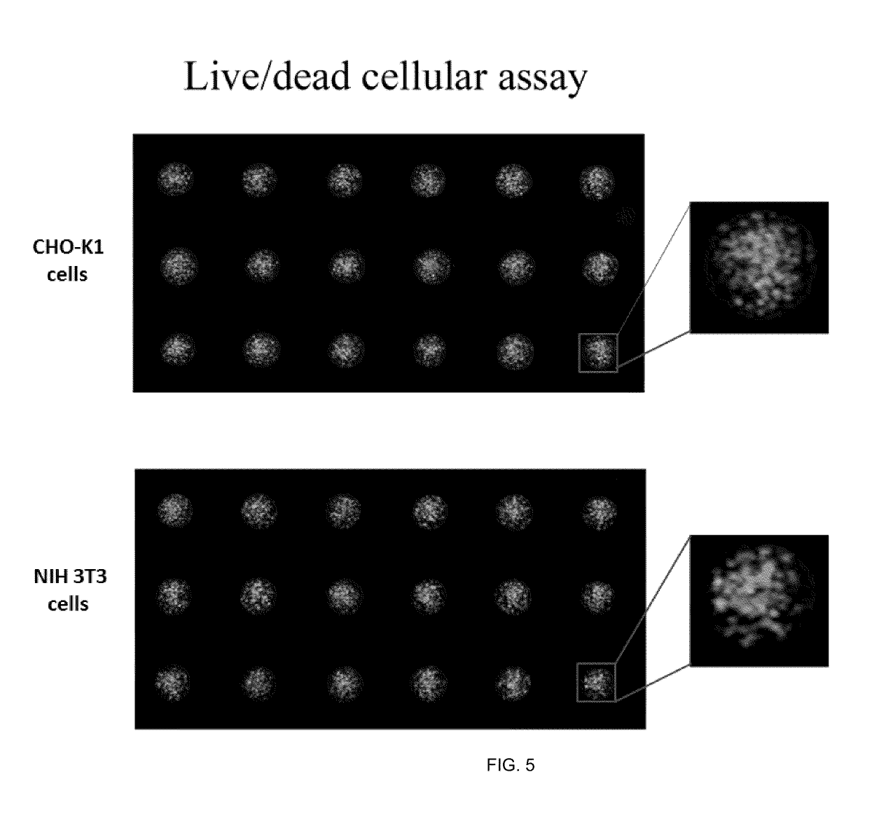

In contrast with non-viral vectors, viruses can encapsulate nucleic acids into neutral particles with small sizes (−100 nm) which we hypothesized would more easily pass through the small pores and negatively charged matrix of the alginate gel, allowing transfection of the cells in the 3D culture. To verify this, we transfected the cells with a retrovirus containing the green fluorescent protein (GFP) gene. After spotting the NIH 3T3 and CHO-K1 cells, the slide was incubated for 24 h in complete medium. The retroviral-GFP solution was then added with polybrene to increase transfection efficiency, and the slides were incubated for 12 h. The virus-containing solution was removed, and the slides were incubated for an additional 48 h. As shown in FIG. 2A, both cell types expressed GFP, with 58% of the CHO-K1 cells and 54% of NIH 3T3 cells exhibiting green fluorescence. To demonstrate the ability of the retroviral constructs to deliver interfering RNA, we performed a subsequent transfection with a retrovirus containing GFP shRNA. After silencing, the GFP green fluorescence signals in the 3D cell-culture chip were significantly reduced (FIG. 2B), with silencing efficiencies of 87% for CHO-K1 cells and 85% for NIH 3T3 cells. To verify that the reduction in signal was due to silencing of the GFP and not toxicity of the shRNA, cell viability was evaluated using Live/Dead staining. As shown in FIG. 5, only viable cells were observed, demonstrating that the retrovirus-GFP shRNA did not cause significant cell death; hence, the reduction in GFP-expressing cells was due to GFP silencing.

To demonstrate the ability of retroviral-shRNA constructs to alter cellular physiology, we selected four shRNAs with known toxicity; plk 1 shRNA, kif 11 shRNA, psma 1 shRNA-1, and psma 1 shRNA-2, for transfection into our 3D culture system, having previously demonstrated the toxicity of these constructs in these cell lines in 2D culture (data not shown). After 12 hours of viral exposure, followed by 48 hours incubation, the cytotoxicity of these constructs was evaluated by Live/Dead staining. As shown in FIG. 2c, these retroviral-shRNAs led to obvious cell death, where the non-viable fraction of CHO-K1 cells ranged from 11% (plk 1 shRNA) to 42% (psma 1 shRNA-2) (FIG. 2d); the corresponding percentages of non-viable NIH 3T3 cells ranged from 10% to 41% (FIG. 2d). As a control, retrovirus with no shRNA constructs caused <1% cell death.

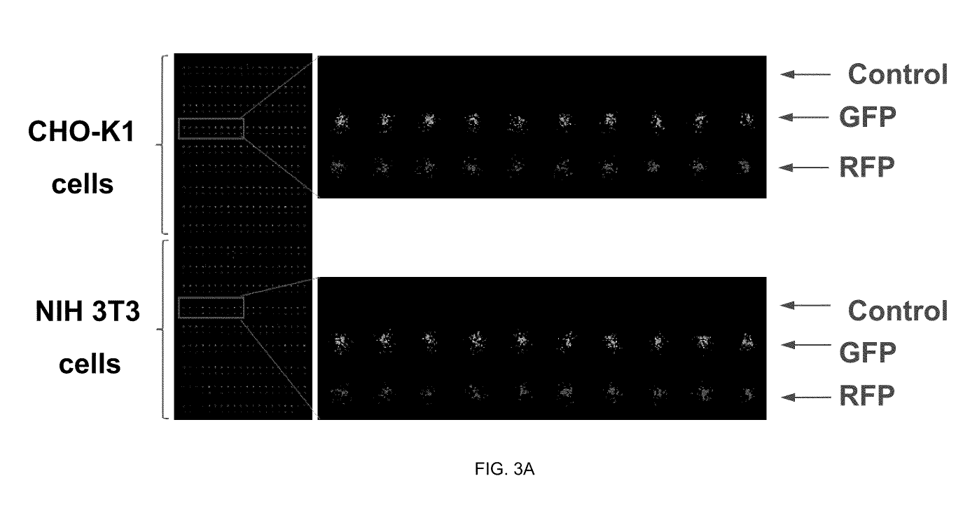

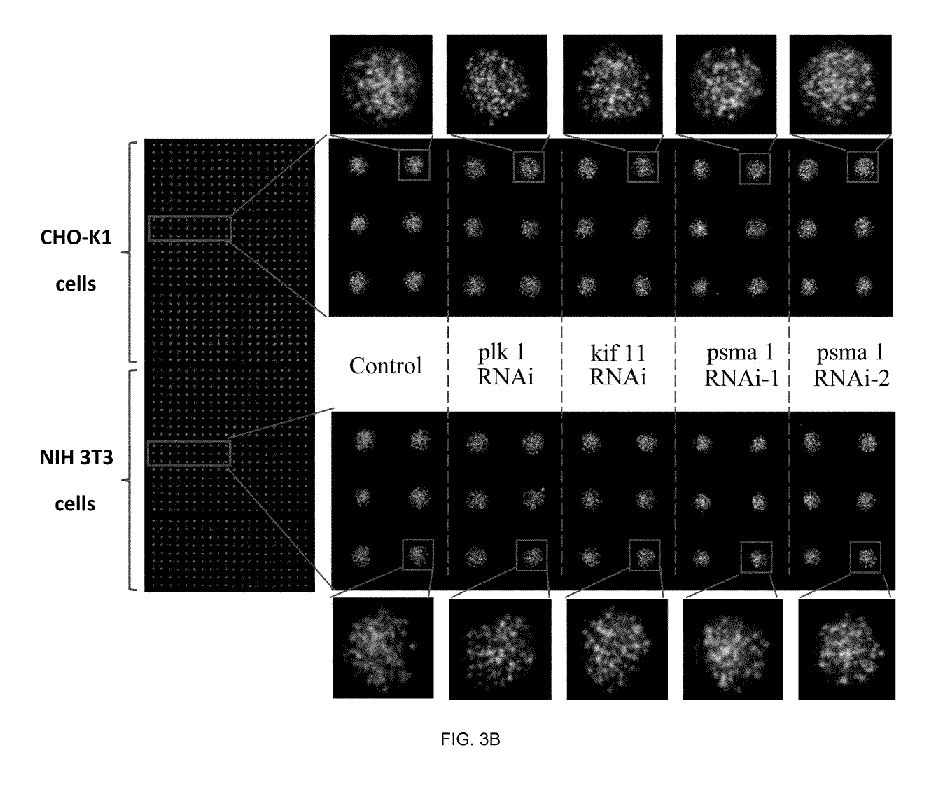

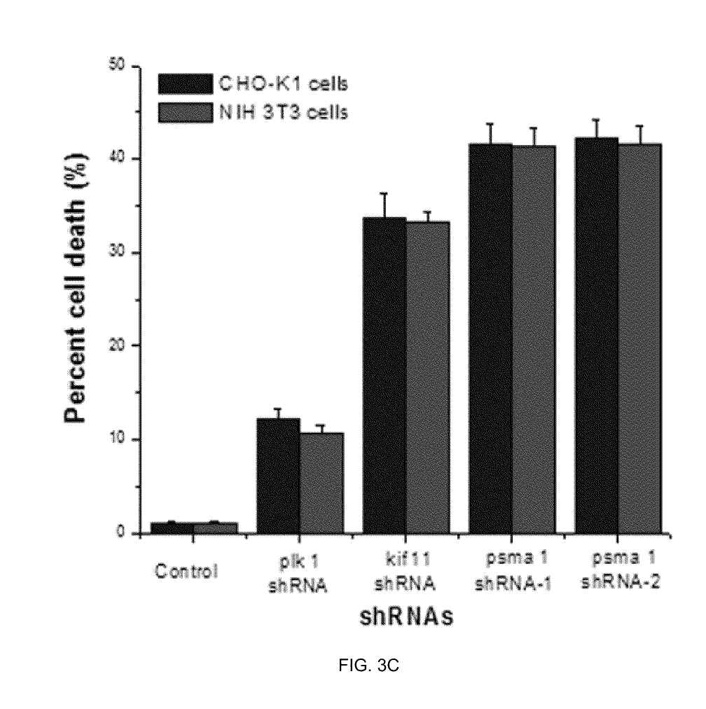

Having demonstrated that retroviruses can deliver genes through the alginate gel matrix and effectively silence both exogenous and endogenous genes, without any apparent toxicity of the retroviral vectors, we next demonstrated that we could apply retroviral transfection in a high-throughput manner. In this process, the retroviral constructs were mixed with alginate to form a retroviral-alginate mixture containing 0.5% (w/w) alginate. Twenty nanoliters of this mixture were spotted onto each PLL-BaCl₂ spot, followed by 40 nL of the cell-alginate solution onto each spot. To demonstrate our ability to apply multiple retroviral constructs and cell lines on a single chip, we spotted retroviral constructs containing GFP and dsRed-Monomer (Clonetech) followed by CHO-K1 or NIH-3T3 cells. As shown in FIG. 3A, we were able to visualize both the red and green constructs in both cell lines. The approximate transfection efficiency was 43% for retroviral-GFP and 41% for retroviral-dsRed-Monomer. Using this procedure there was no sign of retroviral diffusion through the medium as there was no “crosstalk” between the green and red spots.

Finally, we demonstrated that we were able to effectively silence endogenous genes in a high-throughput manner. The four toxic retroviral shRNA constructs applied in solution transfection above were spotted individually in a retroviral-alginate solution (0.5% (w/w) alginate) and overlaid by CHO-K1 or NIH 3T3 cells as shown in FIG. 3B. After incubation, the cytotoxicity of retroviral-shRNAs was evaluated by Live/Dead staining. The cytotoxicity analysis indicated retrovirus alone caused <1% CHO-K1 or NIH 3T3 cell death, while plk 1 shRNA, kif 11 shRNA, psma 1 shRNA-1, and psma 1 shRNA-2 caused 12, 34, 42, and 42% CHO-K1 cell death, respectively and 11, 33, 41, and 42% NIH 3T3 cell death, respectively (FIG. 3C). The relative cytotoxicities were nearly identical to that observed in solution transfection, demonstrating the feasibility and efficiency of using retroviral-shRNAs for high-throughput RNA interference in a 3D cell-culture chip. Hence, we have developed a novel approach to rapidly annotate gene function that is compatible with suspension cultured cells and provides a 3D culture environment, more closely resembling the in vivo milieu. This technique could be readily adapted to functional genomic studies in stem cells or for tissue engineering applications.

### Reagents

Sodium alginate, barium chloride, poly-L-lysine (PLL) (0.01%), poly(styrene-co-maleic anhydride) (PSMA), and POLYBRENE® (hexadimethrine bromide) were purchased from Sigma-Aldrich (St. Louis, Mo., USA). GFP and GFP shRNA individual clones were generous gifts from Professor Douglas Conklin (SUNY Albany) and Professor David Schaefer (UC Berkeley), respectively. pRetroQ-DsRed Monomer-C1 which produces the red fluorescent protein LIVING COLORS® DsRed-Monomer from a retroviral construct was purchased from Clontech (Mountain View, Calif.) Retroviral shRNA constructs for four “toxic” shRNAs (psma 1 shRNA-1, psma 1 shRNA-2, plk 1 shRNA, and kif 11 shRNA) were purchased from OpenBiosystems (Huntsville, Ala.). VIRABIND® retrovirus concentration and purification kit was purchased from Cell Biolabs (San Diego, Calif.). MOLECULAR PROBES® LIVE/DEAD® Viability/Cytotoxicity Kit (catalog #L3224) based on calcein AM and ethidium homodimer-1 staining was purchased from Invitrogen. Glass microscope slides were obtained from Fisher Scientific (Pittsburgh, Pa.) and 0.45 μm filtration units were purchased from Millipore (Billerica, Mass.).

### Cell Culture

NIH 3T3 cells (generously provided by Professor George Plopper at RPI), Phoenix-amphotropic and Phoenix-ecotropic retrovirus packaging cells (generously provided Professor Douglas Conklin at SUNY Albany) were cultured in Dulbecco's modified Eagle's medium (DMEM) (Hyclone, Logan, Utah) supplemented with fetal bovine serum (10%), penicillin (100 U/mL), streptomycin (100 mg/mL) and glutamine (2 mM) (all from Hyclone, Logan, Utah) at 37° C., 5% CO₂. CHO-K1 cells (ATCC, Manassas, Va.) were cultured in DMEM/F12 medium (Hyclone, Logan, Utah) supplemented with fetal bovine serum (10%), penicillin (100 U/mL), streptomycin (100 mg/mL) and glutamine (2 mM). Cells were grown routinely in T-75 tissue culture flasks and passaged by trypsinization.

### Preparation of Retroviral Solutions

Plasmids containing the shRNA constructs in a retroviral vector were amplified in E. Coli and purified using a Qiagen plasmid maxi kit (Valencia, Calif.) as per the manufacturer's instructions. Retroviral solutions were prepared according to the Phoenix-helper dependent protocol provided by Garry Nolan (Stanford University) (http://www.stanford.edu/group/nolan/protocols/pro_helper_dep.html). Briefly, 1.5×10⁶ Phoenix-amphotropic or Phoenix-ecotropic cells were seeded in each 60 mm dish in 3 mL DMEM medium. After 24 h, cells were treated with chloroquine (25 μM) for 5 min followed by transfection of the plasmid DNA by calcium phosphate precipitation in the presence of chloroquine (1 ml of solution containing 8 μg DNA, 0.12 M CaCl₂, 25 mM HEPES, 0.75 mM Na₂HPO4, 140 mM NaCl, pH=7.0 per 60 mm dish) for 24 h at 37° C. in 5% CO₂ incubator. The original medium was aspirated and replaced with 3 mL fresh complete DMEM medium. The cells were then incubated at 32° C., 5% CO₂ for 24 h. The supernatants was harvested and filtered through a 0.45 μm PVDF filter to remove cell debris. 21 mL of fresh retrovirus solution (for each construct) was then concentrated to 300 μL, using a VIRABIND® retrovirus concentration and purification kit according to the manufacture's protocol. 300 μL of concentrated retrovirus produced by Phoenix-amphotropic cells was mixed with 300 μL of concentrated retrovirus produced by Phoenix-ecotropic cells to form the final concentrated retrovirus solution used for slide transfection.

### Microarray Slide Fabrication

Borosilicate glass slides (25×75 mm²) used for the transfection microarrays were treated with PSMA to create a hydrophobic surface [16, 17]. Briefly, slides were prewashed with ethanol followed by acid treatment in concentrated sulfuric acid (98%) overnight to remove dust and oil from the glass surface. The slides were then sonicated for 30 min in distilled water and rinsed in deionized water five times and then once in acetone. The cleaned glass slides were dried using a nitrogen gas stream and then baked at 120° C. for 15 min prior to use. The surfaces of the acid-cleaned glass slides were coated with PSMA by spin-coating 1.0 mL of 0.1% PS-MA (w/v) in toluene on the top of each slide at 3000 rpm for 30 s using spin coater Model PWM32, Headway Research, Inc. The PSMA-coated slides were dried overnight at room temperature on the bench.

### 3D Cell Culture and Conventional Retroviral Transfection on Slides

To generate individual alginate spots, a PLL-BaCl₂ aqueous solution (33.3 mM BaCl₂, 0.0067% PLL) was spotted onto the PSMA-coated glass slides using a Microsys 5100-4SQ noncontact microarray spotter (Genomic Solution, Ann Arbor, Mich., USA) equipped with an extended head. To minimize the risk of contamination, the microarrayer spotting chamber was sterilized with 70% ethanol prior to use. 1080 spots, each containing 40 mL of PLL-BaCl₂ solution were spotted onto each slide. The PLL-BaCl₂ spotted slides were dried in sterile a Petri dish at room temperature. A mixture of alginate and cells (either CHO-K1 or NIH 3T3) in DMEM/F12 complete medium was prepared at final concentration of 1% (w/v) and 8×10⁶ cells/mL, respectively. After drying the PLL-BaCl₂ spots, 30 mL of the cell suspension in alginate was spotted on top of the PLL-BaCl₂ spot while maintaining the humidity in the microarrayer chamber at above 95% to retard water evaporation during spotting. Each spotted slide was placed in a 100-mm Petri dish containing 15 mL DMEM/F12 complete medium and incubated at 37° C., 5% CO₂ for 24 h. Subsequently, 300 μL of concentrated retrovirus solution and 15 μL of polybrene (5 mg/mL) were added to the medium and the slide was incubated for 12 h at 37° C., 5% CO₂. The virus-containing medium was removed and 15 mL fresh medium was added to the Petri dish, followed by 48 hours incubation. After 48 hours, fluorescence and viability were measured as described below. In the case of GFP silencing by shRNA against GFP, the retrovirus containing the GFP was incubated for four hours, then the retrovirus containing the shRNA against GFP was added. Twelve hours after the initial retrovirus addition, the virus-containing medium was removed and 15 mL fresh medium was added to the Petri dish.

### 3D Cell Culture and High Throughput Retroviral Transfection

PLL-BaCl₂ spotted slides were prepared as described above. To retard water evaporation during the viral and cell spotting, 150 mL of deionized water was spotted at the edge of the slide, and the humidity in microarrayer chamber was maintained above 95%. 20 nL of concentrated retroviral-shRNA solution containing 0.5% alginate was spotted on the top of PLL-BaCl₂ spot. Immediately after completing all the retroviral spotting, 40 nL of cell suspension in 1.0% alginate was spotted on the top of retrovirus-alginate spot. The spotted slides were placed in 100-mm Petri dishes containing 15 mL DMEM/F12 complete medium and 15 μL of polybrene (5 mg/mL) and incubated at 37° C., 5% CO₂ for 12 h. After removal of the original medium, 15 mL fresh medium was added to the Petri dish, followed by an additional 48-hour incubation. After 48 hours, fluorescence and viability were measured as described below.

### Fluorescence and Viability Assays

Fluorescence signals from green fluorescent protein and DsRed-Monomer were imaged using a GenePix 4000B microarray scanner (Molecular Devices, Sunnyvale, Calif.) and the intensities were analyzed by GenePix Pro 6.0 software (Molecular Devices, Sunnyvale, Calif.) and Photoshop (Adobe Systems, San Jose, Calif.). The cellular viabilities were measured by MOLECULAR PROBES® LIVE/DEAD® Viability/Cytotoxicity Kit (Invitrogen, Carlsbad, Calif.), which produces a green fluorescent response from viable cells and a red fluorescent signal from dead cells. Briefly, each slide was rinsed three times in PBS containing 10 mM CaCl₂ and covered by 1.4 mL of staining solution (2 μM calcein AM, 4 μM ethidium homodimer and 10 mM CaCl₂ in PBS) followed by a 30-minute incubation at room temperature. The staining solution was removed and the slide was rinsed by PBS and dried by gentle nitrogen flow. The green and red fluorescence was imaged and analyzed as described above. Transfection efficiency was evaluated by [(F_{Sam}−Fₘᵢₙ)×T %]/(F_{T}−F_{Min}), where F_{Sam} is the fluorescence intensity of the transfected 3D cell culture chip; F_{T} is the fluorescence intensity of a population of cells with a known transfection efficiency (T %) (based on fluorescence-activated cell sorting) that were subsequently spotted to form a 3D cell-culture chip; F_{Min} is the fluorescence intensity of an untransfected 3D cell-culture chip. Silencing efficiency was evaluated by [(F_{H}−F_{Min})−(F_{Sam}−F_{Min})]×100%/(F_{H}−F_{Min}), where F_{Sam} is the green fluorescence intensity of the silenced 3D cell-culture chip; F_{H} is the green fluorescence intensity of cells in the 3D cell-culture chip transfected by GFP expressing retrovirus; F_{Min} is the green fluorescence intensity of an untransfected 3D cell-culture chip. The cytotoxicities of RNAi molecules were evaluated by percentage of dead cells. The green fluorescence intensity is linearly proportional to the total number of live cells and was quantified from the microscopic images with Photoshop using the histogram function. Dead cells %=100%−[(F_{Sam}−F_{Min})/(F_{Max}−F_{Min})]×100%, where F_{Sam} is the green fluorescence intensity of the 3D cell culture chip treated by RNAi molecules, F_{Max} is the green fluorescence intensity of 100% live cells, and F_{Min} is the green fluorescence intensity of an untreated 3D cell-culture chip.

TABLE 3
Transfection efficiencies of commercially available
transfection reagents in 2D and 3D cell culture.

| | | Transfection Efficiency | |
|---|---|---|---|
| | | (%) | |
| | | 2D | 3D alginate |
| Reagent | Manufacturer | Monolayer | system |
| FuGene HD | Roche | 90-95 | 0 |
| Lipofectamine LTX | Invitrogen | 90-95 | 0 |
| HiPerFect | Qiagen | 70-80 | 0 |
| SiIMPORTER | Upstate | 65-70 | 0 |
| Effectene | Qiagen | 85-90 | 0 |
| Dreamfect Gold | OZ Biosciences | 70-75 | 0 |
| Deliver X Plus | Panomics | 30-40 | 0 |
| Arrest In | Open Biosystems | 80-85 | <1 |
| JetPEI | Polyplus-transfection | 80-85 | <1 |
| PolyMag | OZ Biosciences | 75-80 | <5 |
| NIMT ® FeOfection | Genovis | 75-80 | <15 |

### Example 3

### Transfection of Cells with Silencing RNA Molecules Using Retroviral Constructs

As most silencing RNA molecules are currently available in retroviral constructs, we attempted to infect our cells with a retrovirus containing the gene for GFP in two ways, first, applying the viral solution to the top of the alginate layer as had been done for the transfection reagents (described above) and second, mixing the viral solution with the cells before adding the cells to alginate solution. In both cases, a retrovirus containing the GFP reporter gene was produced by transfecting Phoenix-Ampho cells (a human embryonic 293T cell line) with a plasmid containing the GFP reporter gene. The resulting retrovirus is competent to infect a wide range of species including human and hamster cell lines, but is replication deficient.

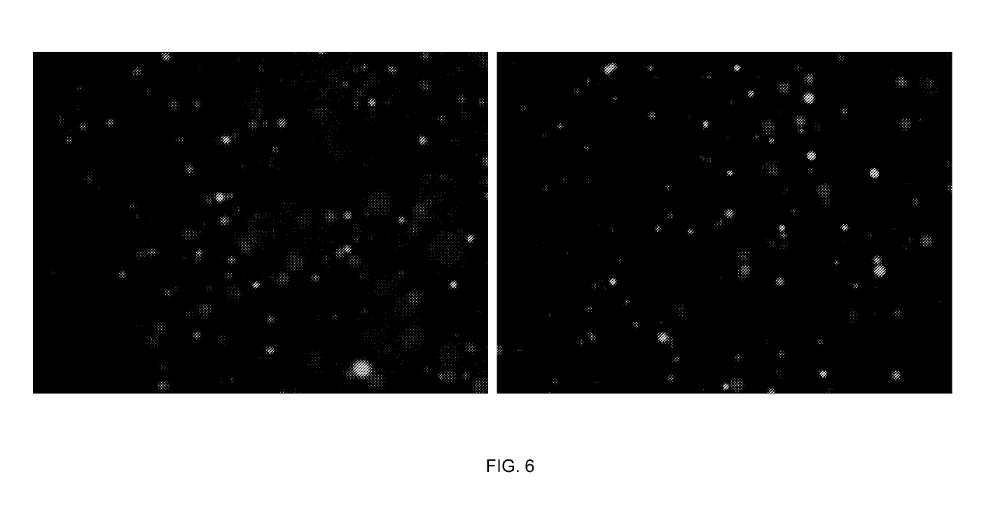

To apply the viral solution to the top of the alginate mixture, the virus containing solution was concentrated using ViraBind (Cell Biolabs, Inc.) and mixed with polybrene to improve infection efficiency. The viral solution was then applied to the top of the alginate matrix and incubated for 24 hours. After 24 hours, the viral solution was replaced with fresh medium and the cells were incubated for an additional 48 hours, followed by analysis using fluorescence microscopy. As shown in Table 2 and FIG. 6, using this method, a significant GFP transfection in both MCF7 and CHO K1 cells was achieved.

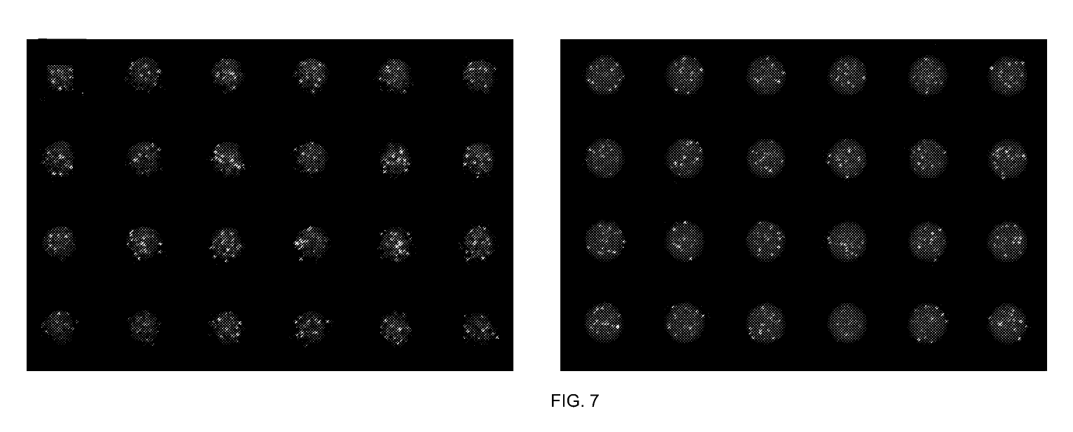

To verify that viral delivery could also be obtained on the DataChip (Solidus Biosciences, Inc; described in U.S. Patent Application Publication No. 20090221441), cell-containing slides were prepared as previously described. Slides were placed into a Petri dish and immersed in complete medium containing the retroviral-GFP solution and polybrene. Slides were incubated for 24 hours. The medium was changed for fresh medium and the slides were incubated for an additional 48 hours. Similar results as obtained in 24 well dishes were seen for cells grown on the DataChip using microarray scanner for data analysis (FIG. 7).

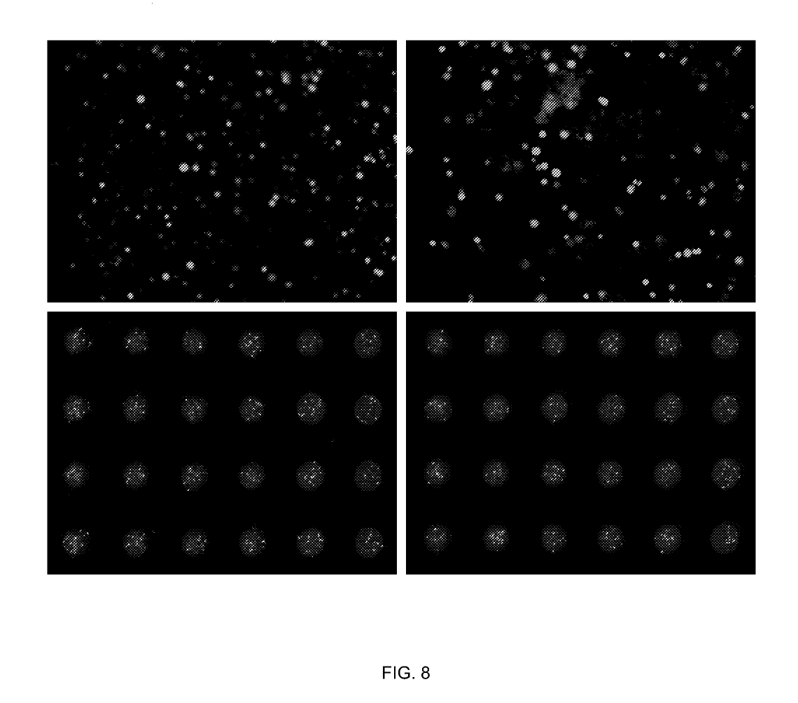

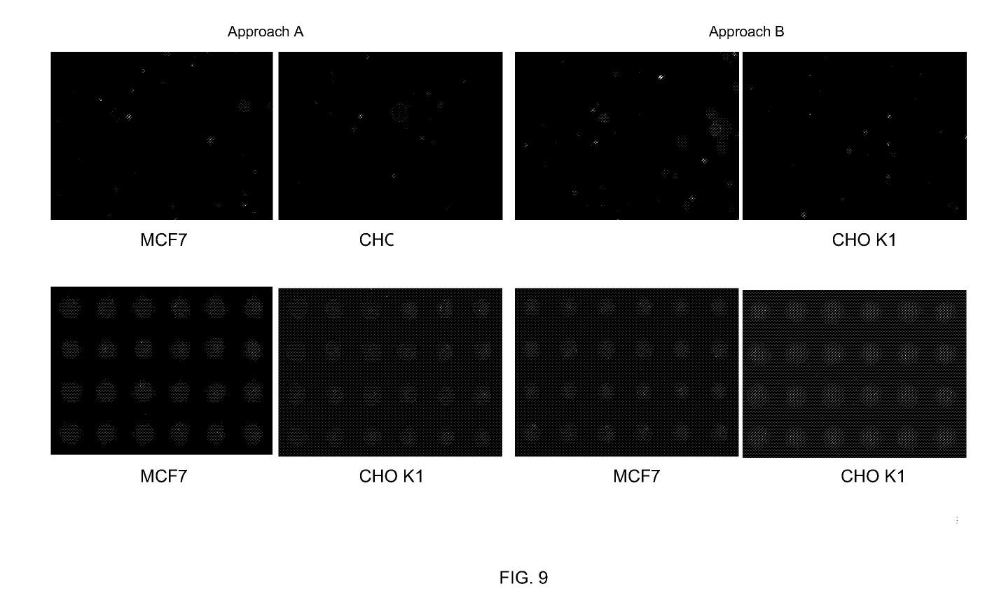

To determine whether improved infection could be obtained by mixing the viral solution with cells prior to formation of the alginate matrix, viral solutions containing polybrene were incubated with the cell solutions for 10 minutes prior to the addition of alginate. The alginate-cell solution containing the virus was then added to the well, allowed to gel for 20 minutes followed by 48 hours incubation in complete medium and analysis by fluorescence microscopy. As can be seen in FIG. 8 and Table 2, the transfection efficiency is markedly better when the virus is mixed into the alginate, suggesting that even with viral delivery methods; there are still mass transfer limitations. Even when the experiment was repeated on the DataChips (FIG. 8 bottom) which should show significantly less mass-transfer resistance due to the very small spot size, the transfection efficiency was improved by adding the viral solution to the cells prior to mixing with the alginate.

TABLE 4
Transfection efficiencies of viral delivery added to cells (%)

| | Delivery method | |
|---|---|---|
| | Viral gene solution added to | Viral gene solution added to |
| Cell line | the top of alginate gel | cells |
| 293 | 60-65 | 80-85 |
| MCF7 | 55-60 | 75-80 |
| CHO K1 | 55-60 | 70-75 |

### Example 4

### Inhibiting Gene Expression Using Viral Delivery Methods

The purpose of this experiment was to demonstrate that silencing RNA could be used to inhibit gene expression. As a proof of principle, the GFP construct was selected for silencing since it could more rapidly be assayed that using toxic silencing RNA. As shown in Table 3 below, silencing GFP expression was successful using the three delivery methods described above.

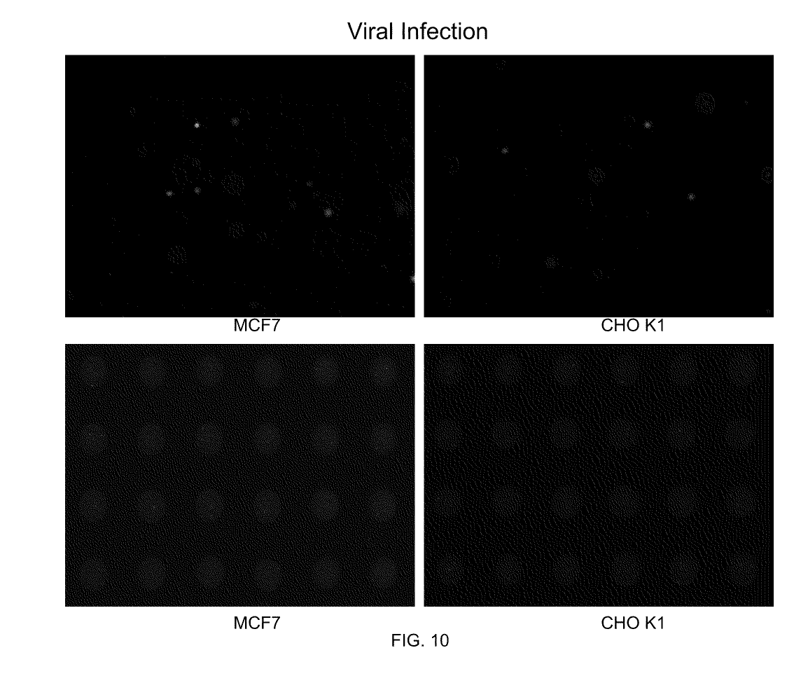

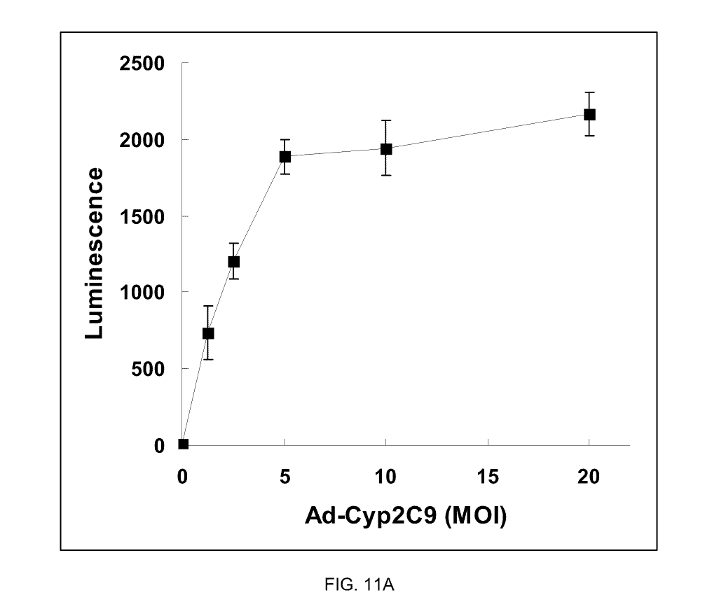

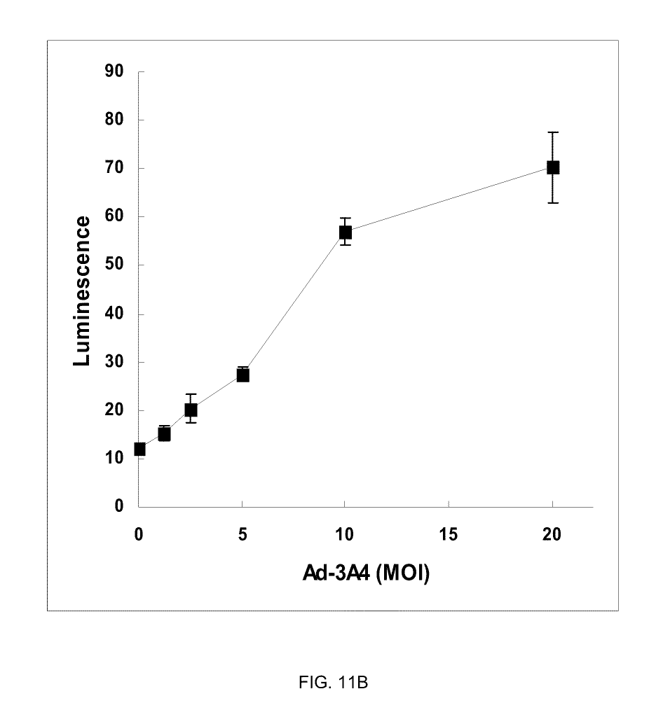

For the first delivery approach, the viral-gene solution was added to the top of the alginate matrix, two silencing approaches were explored. In the first case (Approach A), the GFP virus was transfected into the cells for 24 hours, followed by a 48-hour incubation to allow for GFP expression. The cells were imaged to verify GFP expression, followed by transfection of a retroviral construct containing an shRNA against GFP. In the second case (Approach B), the GFP plasmid and silencing plasmid were delivered simultaneously. As can be seen in FIG. 10, both approaches were successful in both 24-well plates and on the DataChips. Similarly, combining both the GFP plasmid and the silencing plasmid with the cells before additing the alginate was effective at silencing the GFP construct using viral gene delivery (FIG. 11). The silencing efficiencies for all gene delivery methods are given in Table 3 below.

TABLE 5
Silencing efficiency of shRNA against GFP (%)

| | Delivery method | | |
|---|---|---|---|
| | Viral gene solution | Viral gene solution | |
| | added to the top of | added to the top of | Viral |
| | alginate gel | alginate gel | gene solution |
| Cell line | (Approach A) | (Approach B) | added to cells |
| 293 | 75-80 | 80-85 | 85-90 |
| MCF7 | 75-80 | 75-80 | 75-80 |
| CHO K1 | 75-80 | 80-85 | 70-75 |

### Example 5

### Expression of CYP3A4 and CYP2C9 in HepG2 Cells

Cytochromes P450 including CYP2C9 and CYP3A4 were expressed in HepG2 cells with recombinant adenoviruses carrying CYP2C9 and CYP3A4 genes (Ad-2C9 and Ad-3A4). Briefly, HepG2 cells (4×10⁴ cells/well, 100 uL cell culture media/well) were plated in 96-well plates and then Ad-2C9 and Ad-3A4 particles at varying concentrations (MOI=20, 10, 5, 2.5, 1.25, 0) were added into each wells containing HepG2 cells. After 24 h incubation at 37° C., the 96-well plates were further incubated with Luciferin-H (for 2C9) and Luciferin-PFBE (for 3A4) for 3-4 h for enzymatic activity assays. As shown FIGS. 11A and 11B, we were able to detect CYP2C9 and CYP3A4 activities with HepG2 cells infected with Ad-2C9 and Ad-3A4. In addition, the enzymes activities were corresponded to the number of viral particles we added into 96-wells.

### Example 6

### Acetaminophen-Induced Toxicity with HepG2 Cell Expressing CYP3A4

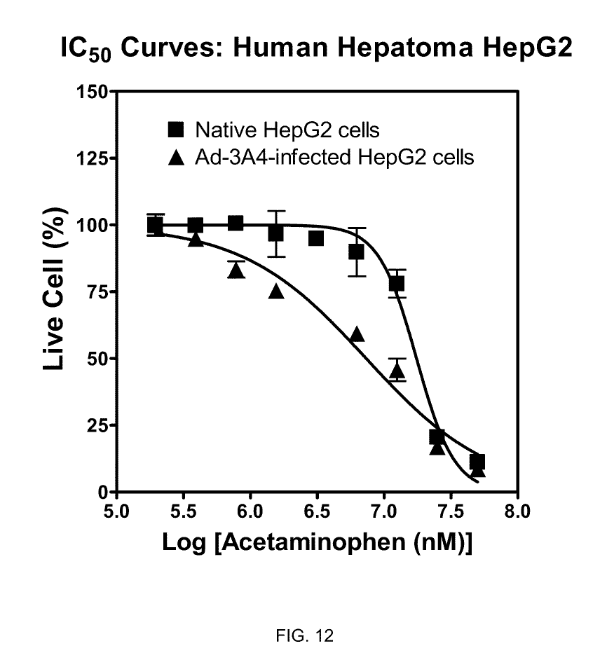

Metabolism-induced toxicity assay was performed with acetaminophen on HepG2 cells expressing CYP3A4. After transfecting HepG2 cells with Ad-3A4 at 40 MOI, HepG2 cells were exposed to acetaminophen at varying concentrations for 24 h. As shown in FIG. 12. HepG2 cell viability decreased as acetaminophen concentration increased. In addition, calculated IC₅₀ values of acetaminophen obtained from parent HepG2 cells (control) and Ad-3A4 infected HepG2 cells were 17.5 mM and 7.3 mM, respectively. These results indicated that native HepG2 cells contains inherent CYP3A4, and the level of CYP3A4 expression can be increased when the cells are infected with Ad-3A4, eventually leading to more cell death because CYP3A4 converts acetaminophen into toxic metabolites.

### REFERENCES

1. Ziauddin, J. & Sabatini, D. M. Nature 411, 107-110 (2001).
2. Silva, J. M., Mizuno, H., Brady, A., Lucito, R. & Hannon, G. J. Proc. Natl. Acad. Sci. USA 101, 6548-6552 (2004).
3. Bailey, S, N., Ali, S. M., Carpenter, A. E., Higgins, C. O. & Sabatini, D. M. Nat. Methods 3, 117-122 (2006).
4. Ostrovidov, S., Jiang, J. L., Sakai, Y. & Fujii, T. Biomed.l Microdevices 6, 279-287 (2004).
5. Sivaraman, A. et al. Curr. Drug Metabol. 6, 569-591 (2005).
6. Yamada, K. M. & Clark, K. Nature 419, 790-791 (2002).
7. Lee, M. Y. et al. Proc. Natl. Acad. Sci. USA 105, 59-63 (2008).
8. Fernandes, T. G., et al. Anal. Chem. 80, 6633-6639 (2008).

While this invention has been particularly shown and described with references to preferred embodiments thereof, it will be understood by those skilled in the art that various changes in form and details may be made therein without departing from the scope of the invention encompassed by the appended claims.

1. A three-dimensional cell culture array comprising spatially-separated matrices attached to a solid support, wherein a plurality of said matrices encapsulate cells transfected with a nucleic acid.

2. The array of claim 1, wherein the nucleic acids are delivered to said cells using a viral vector.

3. The array of claim 1, wherein the cells are mammalian cells.

4. The array of claim 1, wherein the nucleic acid is DNA.

5. The array of claim 1, wherein the nucleic acid is RNA.

6. The array of claim 5, wherein the nucleic acid is capable of mediating RNA interference.

7. The array of claim 6, wherein the nucleic acid is siRNA.

8. The array of claim 6, wherein the nucleic acid is shRNA.

9. The array of claim 1, wherein the nucleic acid is an antisense nucleic acid.

10. The array of claim 1, wherein said micromatrices are alginate or collagen micromatrices.

11. The array of claim 1, wherein at least two matrices comprise different cell types.

12. The array of claim 1, wherein at least two different viral vectors are used.

13. The array of claim 1, wherein the support is chemically modified with an agent that provides a hydrophobic surface on the solid support.

14. The array of claim 1, wherein the support is chemically modified with an agent selected from the group consisting of poly(styrene-co-maleic anhydride), 3-(aminopropyl)trimethoxysilane (APTMS), methyltrimethyoxysilane and a combination of any of thereof.

15. The array of claim 1, wherein the solid support is made from glass or plastic.

16. The array of claim 15, wherein the solid support is a glass slide.

17. The array of claim 3, wherein the mammalian cells are selected from the group consisting of Chinese hamster ovary (CHO) cells, NIH3T3 cells, Hep3B cells, human embryonic kidney cells, A293T cells and cancerous cells.

18. A method of preparing the cell-culture array of claim 1, comprising contacting cells with a virus that encapsulates a nucleic acid to be delivered to said cells.

19. The method of claim 18, wherein the virus is applied to cells by overlaying a matrix that encapsulates the cells with a solution comprising the virus.

20. The method of claim 18, wherein the virus is applied to cells by overlaying a solution comprising the virus with a solution comprising said cells.

21. The method of claim 18, comprising preparing cells infected with said virus and co-culturing said infected cells with the cells of the three-dimensional array.

22. The method of claim 18, wherein the virus is selected from a retrovirus, an adeno-associated virus and an adenovirus.

23. The method of claim 18, wherein the cells are mammalian cells.

24. The method of claim 18, wherein the nucleic acid is DNA.

25. The method of claim 18, wherein the nucleic acid is RNA.

26. The method of claim 25, wherein the nucleic acid is an RNA capable of mediating RNAi.

27. The method of claim 26, wherein the nucleic acid is siRNA.

28. The method of claim 26, wherein the nucleic acid is shRNA.

29. The method of claim 14, wherein said matrices are alginate biomatrices.

30. The method of claim 18, wherein the cells are selected from the group consisting of Chinese hamster ovary (CHO) cells, NIH3T3 cells, Hep3B cells, human embryonic kidney cells, A293T cells and cancerous cells.

31. The method of claim 18, wherein the method is high-throughput.

32. A method of decreasing target gene expression in cells on a three-dimensional cell culture array, said method comprising contacting said cells with a virus that encapsulates a nucleic acid to be delivered to said cells, wherein said nucleic acid is interference RNA or antisense DNA, said array comprises spatially-separated biomatrices attached to a solid support, and a plurality of said biomatrices encapsulate the cells.

33. The method of claim 32, wherein the target gene is an endogenous gene.

34. The method of claim 32, wherein the target gene is an exogenous gene.

35. The method of claim 32, wherein the nucleic acid is an antisense nucleic acid.

36. The method of claim 32, wherein the nucleic acid is an RNA capable of mediating RNAi.

37. The method of claim 36, wherein the nucleic acid is shRNA.

38. The method of claim 36, wherein the nucleic acid is siRNA.

39. A method of assaying the effect of a test compound on a cell comprising providing a three-dimensional cell culture array comprising spatially-separated matrices attached to a solid support, wherein a plurality of said matrices encapsulate cells transfected with nucleic acids, contacting said three-dimensional cell culture with a test compound and assaying the effect of the test compound on the cells.

40. The method of claim 39 wherein the toxic effect of a test compound is assayed.
